(19) United States
(12) Patent Application Publication
(10) Pub. No.: US 2017/0028316 A1
(43) Pub. Date: Feb. 2, 2017

(54) DUAL HELIX CYCOLINIC VERTICAL SEPERATOR FOR TWO-PHASE HYDROCARBON SEPARATION

(71) Applicant: William D. BOLIN, Spring, TX (US)

(72) Inventor: William D. BOLIN, Spring, TX (US)

(21) Appl. No.: 15/223,878

(22) Filed: Jul. 29, 2016

Related U.S. Application Data
(60) Provisional application No. 62/198,544, filed on Jul. 29, 2015.

(51) Int. Cl. B01D 19/00; B04C 9/00; B04C 5/103

(52) U.S. Cl. CPC B01D 19/0057; B04C 5/103; B04C 9/00; B04C 2009/005

(57) ABSTRACT

A cyclonic vertical separator for two-phase hydrocarbon separation is provided, the separator including at least a double helix finned cyclonic device such as a double helix screw for separating associated process fluids into gasses, liquids, and combinations thereof. The double helix finned cyclonic device is disposed in electro-mechanical communication with an electronic submersible pump, either statically, as a removable package, or in series on associated electronic submersible pump tubing. The double helix screw includes a pair of threaded helical surfaces surrounding a central pipe shaft that defines a first helix surface for the handling of liquids and a second helix surface for the handling of gas. In practice, an upper portion of the cyclonic separator primarily handles gas and lesser amounts of liquids, and a lower portion of the cyclonic separator primarily handles liquids and lesser amounts of gas.

### CROSS-REFERENCE TO RELATED APPLICATIONS

The instant application claims the benefit of prior U.S. Provisional Application No. 62/198,544, filed July 29, 2015.

### FIELD OF THE INVENTION

The present invention relates generally to methods and means for producing oil and gas wells at lower mud-line pressures when operating a subsea production system from a process/production facility, and in a specific though non-limiting embodiment, to a dual helix cyclonic vertical separator useful in systems carrying out the two-phase liquid/gas separation such as a vertical annulus separator and pumping system (VASPS) employed in various mud-line operations.

### BACKGROUND OF THE INVENTION

Vertical annulus separator and pumping system (VASPS) are known in the prior art. VASPS typically consist of a vertical separator disposed in fluids in communication with an inlet near the top of the structure, and some type of compartment(s) where liquids can fall to the bottom while gas flows to the top.

In February 2007, Anadarko Petroleum Corporation installed an electrical submersible pump (ESP) in an existing subsea riser off Nansen Spar Facility in East Breaks Block 602 in the Gulf of Mexico. The ESP helped increase production, but was limited by the subsea riser inside diameter and a lack of fluid/gas separation that might help the ESP lift the fluids. Thus, an ESP in a riser is one form of subsea pumping, but is very limited in applications.

Known shallow water (for example, 300 feet or less) VASPS designs have typically been impractical for offshore water applications. For example, they generally require a large size and elevated pressure-ratings for deeper water depths, and subsea systems make them difficult to design, construct and install in deeper water applications.

The respective systems' separation efficiency and their remote disposition can be a considerable problem. For example, the designs suffer from a lack of pressure-rated compatibility due to their large designs, and when there is a need for intervention for maintenance or modification of hardware at the mud-line, the design and access is challenging. Nonetheless, for hydrocarbon production to occur on offshore process/production structures, well riser flow lines from the subsea infrastructure are required to allow flow. Hydrocarbon production from wells in a subsea facility is inhibited from producing hydrocarbons with higher pressure in the subsea system from these subsea risers.

Still other systems are described in references disclosed in an Information Disclosure Statement (“IDS”) accompanying the instant application; see Prior Art FIGS. 1 & 2 herein for representative examples, as well as the patents and articles specifically disclosed in the IDS, the entirety of which is hereby incorporated by reference.

One such system, for example, applies multiple vein-to-supply cyclonic forces to the fluids, and spins the heavier fluids toward the outside of the device so that it falls to the bottom of the structure and can be pumped to the surface using a plurality of different sized pipes. A second includes a screw that causes fluids to flow to the outside of the structure while gas flows toward the inside to a pipe or other tubular located in the middle of the structure; this structure is a static device and requires a pump to lift the liquids to a process/production structure.

Caisson separation has also been attempted in direct vertical access risers with mixed results. In one such operation, a 35-inch, 350 ft. long caisson was inserted into the seabed for liquid retention. An inlet assembly supplied a limited amount of cyclonic force to phase separate the fluids from the natural gas. At the bottom of the 350-foot caisson, acting as sump, was an electrical submersible pump (“ESP”), with tubing using the fluid conduit through the caisson separator to deliver fluid to the surface process/production facility.

Recirculation oil (in liquid form) was necessary to keep the ESP operating rates consistent with changes in the production rate of the subsea well system. (See, for example, U.S. Pat. No. 6,983,802, entitled Method and apparatus for enhancing production from a hydrocarbon-producing well). The recirculation design contributed to foaming as oil was dumped into the system, which required significant quantities of de-foamer to keep the ESP operational even when an ESP pump designed for the handling of significant quantities of gas was employed.

There is, therefore, a longstanding but unmet need for a two-phase separation system that admits to enhanced production of hydrocarbons from a subsea system without the many technical shortcomings present in the prior art.

### BRIEF SUMMARY OF THE INVENTION

A cyclonic vertical separator for two-phase hydrocarbon separation is provided, the separator including at least a double helix finned cyclonic device for separating associated process fluids into gasses, liquids, and combinations thereof In some embodiments, the double helix finned cyclonic device comprises a double helix screw.

In further embodiments, the double helix finned cyclonic device is disposed in electro-mechanical communication with an electronic submersible pump. In still further embodiments, the double helix finned cyclonic device is statically disposed in communication with said electronic submersible pump. In further embodiments still, the double helix finned cyclonic device is installed as a package and is removably disposed with said electronic submersible pump. In yet other embodiments, the double helix finned cyclonic device is installed in series on associated electronic submersible pump tubing.

In one example embodiment, the double helix screw further comprises a complementary pair of threaded helical surfaces. In other embodiments, the complementary pair of threaded helical surfaces surrounds a central pipe shaft that defines a first helix surface for the handling of liquids and a second helix surface for the handling of gas. In still other embodiments, an upper portion of the cyclonic separator primarily handles gas and lesser amounts of liquids, and a lower portion of the cyclonic separator primarily handles liquids and lesser amounts of gas.

In yet another embodiment, a power cable directed toward the electronic submersible pump is installed in a predominantly gas handling portion of the double helix finned cyclonic device so as to not impede cyclonic action occurring within a predominantly liquid handling portion of the double helix finned cyclonic device.

### BRIEF DESCRIPTION OF THE DRAWINGS

FIG. 1 is a plan drawing of an example vertical separator according to the prior art.

FIG. 2 illustrates an example separation of liquids and gasses according to a vertical separation system known in the prior art.

FIG. 3 is a plan view of an example dual helix cyclonic vertical separator for two-phase hydrocarbon separation according to the instant invention.

FIG. 4 illustrates example separation of liquids and gasses according to the dual helix cyclonic vertical separator for two-phase hydrocarbon separation of the instant invention.

FIG. 5 illustrates various example liquid/gas separation characteristics of fluids separated using the dual helix cyclonic vertical separator for two-phase hydrocarbon separation according to the instant invention.

FIG. 6 illustrates various example liquid/gas separation characteristics of fluids separated using a dual helix cyclonic vertical separator for two-phase hydrocarbon separation according to the instant invention.

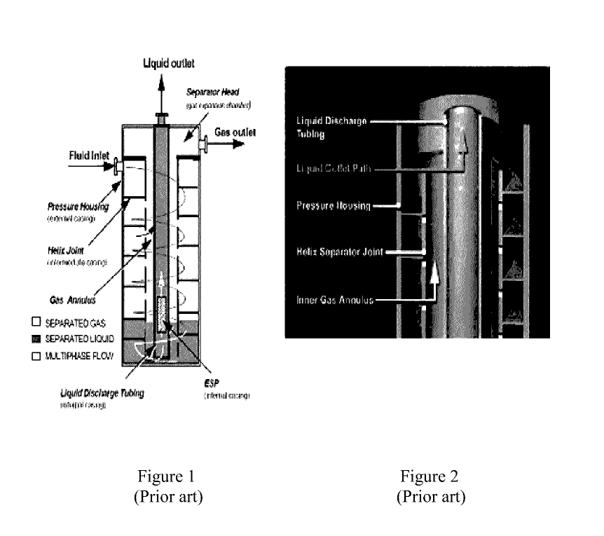

### DESCRIPTION OF SEVERAL EXAMPLE EMBODIMENTS

In one representative embodiment, methods and means are provided to convert a direct vertical access riser on a dry tree, for example, a top tensioned riser supported by a tension leg platform (“TLP”) or a buoyant circular floating structure (“SPAR”) with direct vertical access risers and buoyance cans or other structures that have direct vertical access risers that can function as a mud-line pumping system. This system has the advantage of being accessible from the direct vertical access riser surface facility without the need for subsea intervention vessels, and thus there is much less cost, more availability of facilities, and less chance of pollution from the system during operations and maintenance.

In this conversion, when an ESP installed below the mud-line in a sump requires maintenance or is otherwise cycled out, the ESP is pulled from the surface using, for example, a small work-over rig that can be a hydraulic pulling unit.

There is typically no need for a blowout preventer, because the site is not an active well but rather a controlled vertical flow line to the process/production facility. While known ESPs are available today, a double helix cyclonic assembly is required in which inputs, outputs and connections with orientation matching the flow from the mud-line assembly are provided. In one specific though non-limiting embodiment, the double helix cyclonic assembly is approximately ten feet long (though longer or shorter units can of course be used within the scope of this disclosure) and is installed in series on the ESP production tubing.

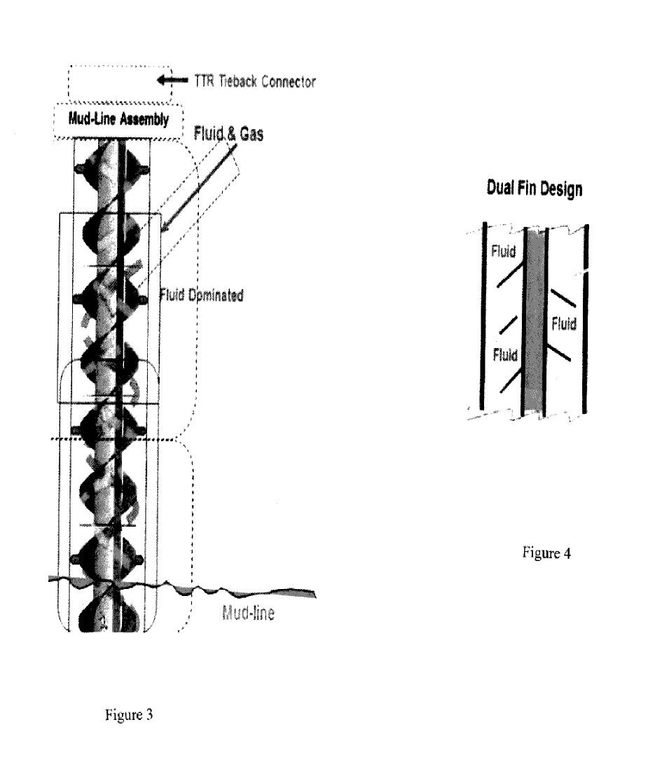

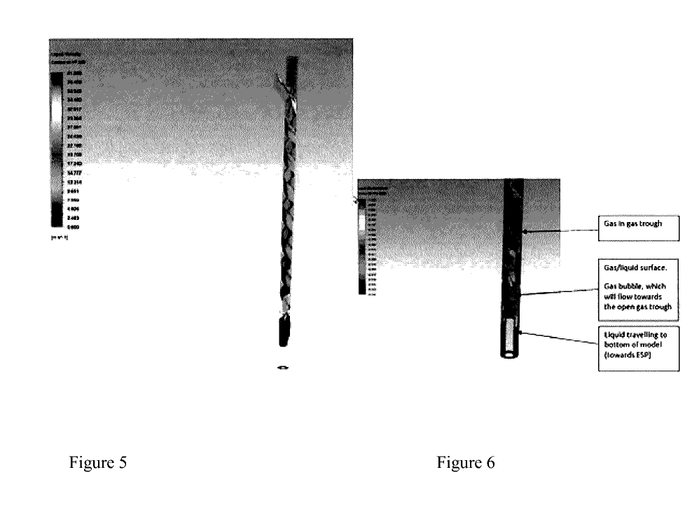

As seen in FIGS. 3 & 4, a double helix finned cyclonic device such as a double helix screw is provided, comprising a complementary pair of threaded helical surfaces surrounding a central cylindrical pipe shaft that defines one helix surface for the handling of fluid and a second helix surface to handle gas.

The dual helix screw is a fixed static device associated with the piping tubing of the ESP. This center tubing is the conduit for the fluid to be pumped to the surface of the process/production facility by the ESP in the lower sump. The natural gas has less density than the fluid and is directed to the second helix area and is allowed to flow up the area outside the tubing above the double helix assembly. With the fluids being pumped, the inlet pressure at the mud-line is set by the pressure losses in the helix assembly (which are very low), and the vertical gas column defines the inlet operating pressure of the process equipment of the process/production facility. The mud-line operating pressure can be very low when a low process/production facility gas inlet production train pressure is low.

Optimally, this helix portion of the device is relatively small in diameter, so that it can be installed together with the ESP on the tubing, and replacement and modification are possible every time the ESP is pulled.

So equipped, the system can pull down the mud-line flowing subsea pressures very low. In this manner, an upper portion of the cyclonic separator primarily handles gas with only a small amount of liquids, while the lower portion of the structure primarily handles liquids with only a small amount of natural gas by volume.

With the dual helix cyclonic two-phase vertical separator system in service, this will be the first process phase from the subsea system to the process/production facility. If the process/production facility has a steel centenary riser (“SCR”) or a vertical production riser, operations will be carried out more smoothly as compared to the fluid surges experienced from other systems. In short, this is the first process phase of the production facility and can provide a smoother operation from a non-pumped riser system that requires the wells to lift the fluids and gas up a riser and experience surges from fluid “fall back” within the riser.

In a further embodiment a power cable to the ESP or other power means is installed in the gas portion of the helix screw assembly so as to not impede the cyclonic action of the fluid packed structure.

From computational fluid dynamics (“CFD”) analysis, the inventor was able to adjust the pitch of the helix screw and the gas cross-over ports between the helix screws and obtain desired performance characteristics for scenarios comprising both 2,000 and 15,000 barrels per day of production at 200 psi mud-line operating pressure. This continuous low operating pressure has not been achieved from the other mud-line pumping systems.

The CFD calculates at 200 psi operating mud-line pressure, a flow rate of 99.375 m³/hr (around 15,000 barrels of liquids per day), and the separator efficiency was 98.5% with a gradient vector flow of 91.35%. The liquids in the gas were 1.5 m³/hr (396 gallons or 1.5%), and the back pressure on the system was calculated at a remarkably low 7.25 psi.

In certain embodiments, an inlet vent renders the liquid film more stable, and increases efficiency to 99.4% with 0.6 m³/hr (158 gal/hr) at the 15,000 bl/d rate.

FIGS. 5 & 6 depict a three-dimensional graphic image of the fluid rotating in the double helix with fluids flowing downward toward the bottom of the structure and the gas flowing upward toward the top of the structure.

The system disclosed herein has many practical advantages over the prior art, including (but not limited to) operational considerations, wax mitigation and hydrate management.

In terms of operational considerations, various aspects of the disclosed system allow an operator to: operate part of the subsea facility well below the pressure needed for surface fluid flow to the process/production facility from existing non pumping lift risers; increase well production because the subsea system operates with less pressure at the mud-line; improve process/production facility operations since the structure is the first separator installed in the system, which will increase the throughput on the process/production facility; remove major surges on the process/production with mainly fluid and gas coming from the installation in a controlled and efficient fashion; maintain a more steady operating pressure on the subsea flowing structure with fewer riser pressure surges; subject the cyclonic vertical riser to few surges, thereby avoiding countermeasures typically required to overcome the gravitational flow of fluid in a riser originating from the mud-line to the process/production facility; add additional reserves from existing wells as operating pressure is reduced that may increase ultimate oil recovery; improve facility operation with reduction of slugging from water risers from the subsea structure; utilize existing surface facility turbine electrical service in order to power an efficient lift ESP; effectively convert a well into a riser, thereby improving the flow-line connection to the subsea system and reducing friction in the existing system; lower subsea flow-line operating pressures, thereby allowing longer step-outs for future production at the facility; and ensure low replacement cost because the modified ESP is installed using a hydraulic unit without the need for a blowout preventer.

In terms of wax mitigation, wax can form in the subsea system where the operating temperatures are low enough for wax precipitation from produced oils. This fluid pumped system will allow lower pressure at the mud-line and can increase fluid flow rates to help mitigate wax using the heat from the oil producing formation. Being a pumped system, it is possible to send hot fluid from the surface facility and then lift this fluid back to the surface without effectively increasing the pressure in the subsea flow line system. This would also allow for “hot-oil” of a loop flow line subsea system to remove wax build-up and then pump the increased fluid for normal operation.

In terms of hydrate management, various aspects of the disclosed system achieve: operational pressures at the base of the process/production facility that can be reduced to a very low 200 psi with a low gas suction pressure on the first stage of the process/production facility, and thus hydrate formation during subsea well start up is avoided; a need for fewer chemicals to ensure a well can be started from a production loop or a lateral and not form hydrates; the start-up of shut-in of a well when not enough chemicals are available to otherwise prevent hydrate formation; a faster start-up after a shut-in as wells come online without the chemicals typically needed to combat hydrates; reduced chemical costs and storage space needed for chemicals on the process/production facility; and remediation of hydrates by depressing the process/production facility side of a hydrate in the subsea lines.

Hydrates can otherwise form when natural gas and water are mixed at low temperatures and high pressures. One example is in the Gulf of Mexico; the deeper water mud-line water temperature is typically 40 degrees Fahrenheit, which creates the possibility of a hydrate problem from the temperature and the pressure needed to produce up a riser in deep-water applications. On start-up of a well that has been shut-in for a period of time and operating below the bubble point pressure, the gas will collect in the top of the well. Starting a well that puts natural gas into the pressurized flow line system will cause hydrates in the subsea system if temperatures are low.

This gas will form hydrates if water is present in the line and the hydrates will seal off the flow line from production. After a hydrate forms, it is hard to correct the problem in 40 degrees Fahrenheit sea water temperature and pressure from the subsea system on the ocean floor. The industry has in the past typically used chemicals to reduce the formation of hydrates or circulation oil into the flow line system so there is very little water present. Both of these operational practices have problems ensuring there are enough chemicals in the correct location, and it is difficult to get all of the water out of a flow line system that is radially connected to a well from a loop production system. Starting at a low pressure subsea system can remove this operational problem.

A great many other advantages and variations of the instant disclosure will readily occur to an ordinarily skilled artisan, even if significant departures from the non-limiting disclosure of structures and operations described herein are practiced. Nowhere in the art of record, whether considered alone or in combination, is a two-phase cyclonic vertical separator such as a double helix cyclonic two phase separator or the like known or used for separating fluids and gas in a riser production facility.

The foregoing specification is provided for illustrative purposes only, and is not intended to describe all possible aspects of the present invention. Moreover, while the invention has been shown and described in detail with respect to several exemplary embodiments, those of ordinary skill in the relevant arts will appreciate that minor changes to the description, and various other modifications, omissions and additions may also be made without departing from either the spirit or scope thereof.

1. A cyclonic vertical separator for two-phase hydrocarbon separation, comprising:
a double helix finned cyclonic device for separating associated process fluids into gasses, liquids, and combinations thereof.

2. The cyclonic vertical separator for two-phase hydrocarbon separation of claim 1, wherein said double helix finned cyclonic device comprises a double helix screw.

3. The cyclonic vertical separator for two-phase hydrocarbon separation of claim 1, wherein said double helix finned cyclonic device is disposed in electro-mechanical communication with an electronic submersible pump.

4. The cyclonic vertical separator for two-phase hydrocarbon separation of claim 3, wherein said double helix finned cyclonic device is statically disposed in communication with said electronic submersible pump.

5. The cyclonic vertical separator for two-phase hydrocarbon separation of claim 3, wherein said double helix finned cyclonic device is installed as a package and is removably disposed with said electronic submersible pump.

6. The cyclonic vertical separator for two-phase hydrocarbon separation of claim 3, wherein said double helix finned cyclonic device is installed in series on associated electronic submersible pump tubing.

7. The cyclonic vertical separator for two-phase hydrocarbon separation of claim 2, wherein said double helix screw further comprises a complementary pair of threaded helical surfaces.

8. The cyclonic vertical separator for two-phase hydrocarbon separation of claim 7, wherein said complementary pair of threaded helical surfaces surrounds a central pipe shaft that defines a first helix surface for the handling of liquids and a second helix surface for the handling of gas.

9. The cyclonic vertical separator for two-phase hydrocarbon separation of claim 1, wherein an upper portion of the cyclonic separator primarily handles gas and lesser amounts of liquids, and a lower portion of the cyclonic separator primarily handles liquids and lesser amounts of gas.

10. The cyclonic vertical separator for two-phase hydrocarbon separation of claim 1, wherein a power cable directed toward the electronic submersible pump is installed in a predominantly gas handling portion of the double helix finned cyclonic device so as to not impede cyclonic action occurring within a predominantly liquid handling portion of the double helix finned cyclonic device.
